(19) United States
(12) Patent Application Publication
(10) Pub. No.: US 2004/0025729 A1
(43) Pub. Date: Feb. 12, 2004

(54) Method and apparatus for imaging a lithographic printing plate

(75) Inventors: Howard A. Fromson, Stonington, CT (US); William J. Rozell, Vernon, CT (US)

Correspondence Address: ALIX YALE & RISTAS LLP, 750 MAIN STREET, SUITE 1400, HARTFORD, CT, 06103, US

(73) Assignee: Howard A. Fromson

(21) Appl. No.: 10/601,382

(22) Filed: Jun. 23, 2003

Related U.S. Application Data
(63) Continuation-in-part of application No. 10/324,918, filed on Dec. 20, 2002.
Application No. 10/324,918 is a continuation-in-part of application No. 10/213,831, filed on Aug. 6, 2002, now abandoned.

(51) Int. Cl. B41N 3/00

(52) U.S. Cl. 101/463.1

(57) ABSTRACT

A lithographic printing plate has a hydrophilic substrate and an oleophilic coating. The plate is simultaneously imaged and developed by applying a solvent for the coating in an image-wise pattern using a jet printer. The oleophilic coating is thereby removed in those areas where the solvent has been jetted exposing the hydrophilic substrate and leaving the residual oleophilic coating in the form of the desired positive image. Because the jetting of the solvent in the image-wise pattern may not apply solvent at the leading and trailing ends of the plate, a strip of solvent is applied to these ends by a separate applicator. Also, separate applicators may apply the solvent to the side edges of the plate. The residual oleophilic coating may be post treated to insolubilize and/or harden the image.

This application is a continuation-in-part of application Ser. No. 10/324,918 filed Dec. 20, 2002, which is a continuation-in-part of application Serial No. 10/213,831 filed Aug. 6, 2002.

The present invention relates to a method and apparatus for producing an imaged, processed lithographic printing plate in a one-step process comprising simultaneously imaging and developing the plate by delivering a solvent in an image-wise pattern by ink jet. The invention specifically involves the removal of the soluble coating on one or more of the leading and trailing ends and side edges of the plates.

### BACKGROUND OF THE INVENTION

There are presently several techniques proposed to make imaged lithographic printing plates using ink jet technology. One obvious method is to apply an oleophilic material in an image-wise pattern by ink jet directly onto a hydrophilic substrate. This method suffers from several drawbacks. It is problematic to find an ink that has good properties for jetting and is substantial enough to endure as the image area on a printing plate for a satisfactory number of impressions. Also, since the hydrophilic substrates are often roughened to improve plate performance, they do not serve as good receiving surfaces for jetted inks.

Another alternative method is to ink jet a photomask onto an actinically imageable plate. The plate has a conventional light sensitive coating and may be positive working or negative working. An ink is jetted in an image-wise pattern on the plate surface. The ink is opaque at the wavelength at which coating is sensitive. The plate is blanket exposed to the imaging radiation after the ink jet writing. The light sensitive areas that are not covered by the jetted ink become exposed by the imaging radiation while the areas covered by the opaque ink remain unexposed. The plate is then subjected to development with the appropriate developing solution to remove the soluble areas of the coating.

U.S. Pat. No. 6,014,931 discloses another alternative method for using ink jet technology to image a plate. A hydrophilic substrate is coated with a first layer that is soluble in a solvent. A second coating is applied in an image-wise pattern by ink jet, with the requirement that the second coating have good adhesion to the first coating and be insoluble in the solvent for the first coating. Upon processing the plate with the solvent, the first coating layer is selectively removed in those areas which are not protected by the insoluble second layer. This method is thus positive working since the areas selectively written by the ink jet process are the areas where the coating remains after processing. The disclosure further allows for the use of actinically sensitive coatings and transparent ink jet fluids to allow for the coating to be further hardened after the processing step.

U.S. Pat. No. 6,315,916 is directed at a further alternative technique for using ink jet to image a plate. The plate used has a negative working coating containing a diazo resin. An alkaline fluid is applied in an image-wise pattern by ink jet onto the diazo resin coating. The alkaline fluid causes an insolubilizing reaction to occur in the coating in the ink jet written areas. The plate is then developed to remove the areas of coating which were not written by the ink jet and remain soluble.

Prior U.S. patent application Ser. No. 10/324,918 is directed at an improved method for imaging a lithographic printing plate using ink jet or jetting printhead technology. That method simplifies the imaging and developing of the plate by accomplishing both imaging and developing in a single process. A lithographic printing plate is simultaneously imaged and developed by applying a solvent fluid in an image-wise pattern by a jet printer. The printing plate comprises a hydrophilic substrate with an oleophilic coating. The oleophilic coating is soluble in the solvent fluid which can be selectively applied by the jetting printhead of the jet printer. The oleophilic coating is removed only in those areas where the solvent has been jetted, revealing the hydrophilic substrate beneath the coating in those areas. Thus, imaging and development are accomplished in a single step. However, it is essential that the coating be removed all the way to both the leading and trailing ends of the plate. If the coating on these ends were not removed by the solvent, it would become a part of the oleophilic printing image and would accept ink and print unwanted stripes. At the same time, it is undesirable to have the solvent jetted onto the mechanisms of the jet printer, such as the plate-conveying rollers or support platen, where it would build up over time. Since it is difficult to program the jetting printhead of the printer to apply fluid precisely to the plate ends without also applying fluid beyond the plate ends, it is undesirable to employ the jetting printhead of the printer to apply a film of solvent to the plate ends.

### SUMMARY OF THE INVENTION

The present invention relates to an improvement in a process using a jet printer for applying a solvent fluid in an image-wise pattern to a printing plate comprising a hydrophilic substrate and an oleophilic coating to form a positive image for printing wherein the improvement involves the application of the solvent at the leading and trailing ends of the plates. Specifically, the invention relates to a method and apparatus for the application of the solvent to the plate ends separate and apart from the application of the solvent by the jetting printhead in the image-wise pattern. More specifically, the invention relates to the use of an applicator which contacts the leading end and later the trailing end of a plate and applies a strip of solvent to the ends, preferably from an absorbent pad. An additional feature of the invention is the optional separate application of solvent to the side edges of the plate.

### BRIEF DESCRIPTION OF THE DRAWINGS

FIG. 1 is a plan view illustrating a simplified arrangement of representative apparatus for practicing the method of the present invention.

FIG. 2 is a general side view of the arrangement of FIG. 1.

### DETAILED DESCRIPTION OF THE INVENTION

The printing plate of the present invention comprises a hydrophilic substrate with an oleophilic coating. As described in the previously mentioned prior application Serial No. 10/324,915, the substrate may be any of the hydrophilic substrates suitable for use in printing plate construction. Preferred is an aluminum sheet that has been grained, anodized and optionally post-treated. Suitable techniques for preparing an aluminum sheet as a substrate for a lithographic printing plate are described in U.S Pat. Nos. 4,183,788, Re 29,745 and 3,181,461. This prior art merely shows a few examples of methods or materials suitable for use in the preparation of a lithographic substrate. The oleophilic coating may be any resin or polymeric material that has the appropriate ink receptivity and the necessary mechanical properties to give the required number of printed impressions. The coating is soluble in the solvent fluid that is selectively applied by the jet printer. Examples of oleophilic coating materials include novolac and resole resins and acrylate resins. These materials are soluble in aqueous alkaline solutions. Suitable alkaline solutions include but are not limited to solutions of sodium metasilicate, sodium hydroxide and potassium hydroxide as well as alkaline solutions of phosphate salts and carbonate salts. Alternatively, organic solvents such as acetone, methyl ethyl ketone, 1 methoxy-2- propanol or benzyl alcohol may be used. Aqueous solutions of the compatible organic solvents can be used, as well as mixtures of solvents. Additionally, mixtures comprising an aqueous alkaline solution and a compatible organic solvent can be used. For example, aqueous alkaline solutions of sodium metasilicate to which some amount of benzyl alcohol has been added are useful.

The simultaneous imaging and development of the plate is accomplished by the selective application of the solvent for the oleophilic coating by a jet printer. The volume of solvent delivered must be controlled such that it is the minimum required to cause the dissolution of the coating. If too large a volume is applied, it will tend to spread and undercut the coating. It is thus critical that the volume of the jetted solvent be properly adjusted and matched to the thickness of the coating on any particular plate. The advantage of a jet printer for applying the solvent is that it allows for the delivery of small, controlled volumes of solvent. Further, the solvent should preferably have a contact angle on the coated surface of approximately 90°. If the contact angle is too low, the fluid will spread and the highlights will be lost.

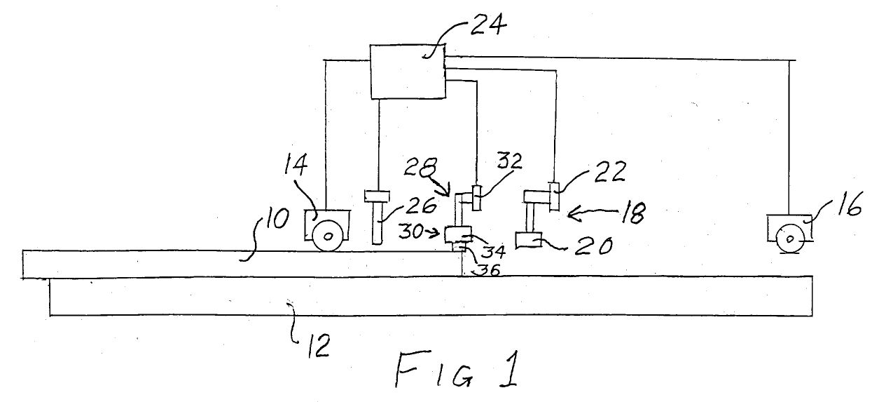

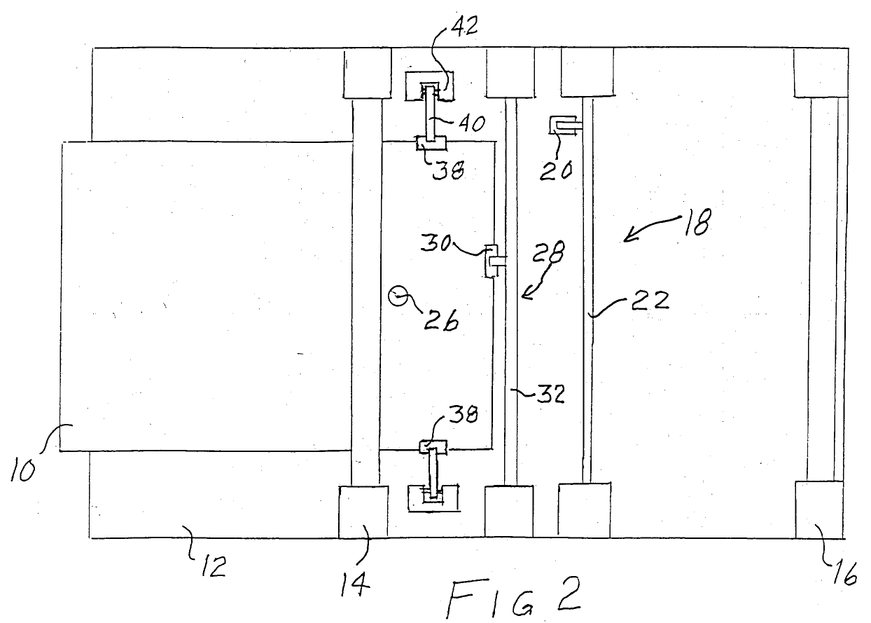

In accordance with the present invention, the application of solvent to the leading and trailing ends of the lithographic printing plates is separate and apart from the application of solvent in an image-wise pattern by the jetting printhead of the jet printer. FIG. 1 is a plan view and FIG. 2 is a side view both illustrating the general arrangement and basic components for practicing the present invention. A lithographic printing plate 10 is fed across a platform 12 by means of the feed rollers 14 and 16. The feed rollers intermittently move the plate just as in a conventional inkjet printer. The platform 12 is preferably composed of conveyor rollers to permit the easy movement of the plate 10 from left to right but these rollers have been omitted from the drawings for clarity. As an alternative, the plate can be supported by a flat platen particularly under the jetting printhead to more closely control the gap between the plate and the printhead. The selective application of the solvent fluid is performed by the jet printer generally designated 18 and including the printhead 20 which is mounted for movement on the track 22. The jet printer 18 is equipment which is well known in the inkjet printer art. The only difference is that the printhead contains the solvent of the present invention instead of ink. In addition to whatever supply of solvent may be contained in the printhead itself, it can readily be connected with a larger reservoir of solvent to keep the printhead supplied with solvent.

The jet printer is connected to the control unit 24. The control unit is again like any control for an inkjet printer and is adapted to receive and store and feed the image data to the printhead. In addition, the control unit 24 receives the input from the optical detector 26 which detects a plate being fed into the apparatus. Since the speed of the plate feed and the distance from the detector to the printhead are known, the control unit 24 activates the jet printer at the proper time to appropriately locate the image on the plate.

In accordance with the present invention, a solvent applicator device 28 is adapted to apply a film of solvent to the leading and trailing ends of the plates. In general, the device is any apparatus which will lay down a strip of solvent across the entire width of the plates at both the leading and trailing ends. The width of the strip will be dependent on the mechanics involved and the programming of the jet printer with respect to the ends of the plates.

In the illustrated arrangement, the solvent applicator device 28 comprises an applicator head 30 which is mounted from the track 32 such that the applicator head can be reciprocated or translated across the ends of the plates. In this arrangement, the track is the same as or similar to a track for a jetting printhead such as the track 22. The solvent applicator device is connected into the control unit 24 such that the detector 26 will cause the solvent applicator device to be activated exactly when the leading end or the trailing end of the plate reaches the proper position with respect to the applicator head 30. The applicator head is composed of a solvent reservoir 34 and an absorbent pad 36 which is kept moist with the solvent. If needed, this reservoir 34 may be connected to a larger reservoir to keep the applicator head supplied with solvent. Alternatives to an absorbent pad for the applicator head can be used such as a narrow roller. The composition of the solvent for the applicator device 28 may very well be different from the specific composition of the solvent for the jet printer. The solvent for the jet printer will usually contain additives to provide the proper jetting properties, as indicated later, which are not needed for the solvent applied by the applicator device.

In a further aspect of the present invention, it may also be desirable to separately apply solvent to the side edges of the plates for the same reason that it is separately applied to the ends, i.e., to prevent or minimize the application of solvent to the printer mechanisms. This feature is shown in FIG. 2 but not included in FIG. 1. The applicator heads 38, which also contain absorbent pads for the solvent, are mounted so that they can be moved into position with the pads contacting the plates. For example, the applicator heads 38 are shown as being mounted on the pivot arms 40 which are pined at 42. Means are provided to pivot these applicator heads 38 into contact with the plates via the control unit in response to the sensing of a plate by the detector 26. Since the solvent on the edges is applied by the pads, the jetting printhead does not need to apply solvent all the way to the side edges.

The coatings which are useful in the present invention may be selected such that they are capable of post treatment to further harden the coating. For example, it is known that phenolic images (novolac and resole resins) can be hardened by heating. Also, examples of such coatings are well known for conventional negative-working lithographic plates. Typically, these are either photopolymer plates or diazo resin plates or combinations thereof. U.S. Pat. No. 3,929,489 discloses condensation copolymers which are capable of being crosslinked by exposure to actinic radiation in either the ultraviolet or visible range. The copolymers generally comprise copolyesters with first dicarboxylic acid derived repeating units containing non-aromatic ethylenic unsaturation capable of providing crosslinking sites and second aromatic decarboxylic acid derived repeating units containing disulfonamido units containing monovalent cations as amino nitrogen atom substituents. Coating compositions of the copolymers are soluble in solvents such as benzyl alcohol, cyclohexanone, dioxane, and 2-methoxyethyl acetate. As such, any of these are suitable fluids for application by ink jetting according to the method of the present invention. Once again, the organic solvents which are compatible may be employed as an aqueous solution. The copolymers are also soluble in aqueous alkaline solutions and these may optionally be used as the ink jetted solvent in the writing process. After imaging, the copolymers may be crosslinked by subsequent exposure to actinic radiation.

Alternatively, coating containing diazo resins may be imaged by the method of the present invention and subsequently exposed to UV radiation. One such suitable diazo resin is the condensation product of 3-methoxy-4 diazo-diphenylamine and paraformaldehyde. Other suitable diazo compounds are described in U.S. Pat. Nos. 3,406,159 and 3,311,605. These compositions are typically soluble in benzyl alcohol and various ketones and glycol ethers. Thus any of these solvents including aqueous solutions thereof can be applied by ink jetting according to the method of the present invention to selectively remove a diazo resin coating. After the ink jet imaging, the coating may be exposed to UV radiation to insolubilize and harden the image.

Included in the jetting solvent there may be selected additives to provide the required jetting properties. Such materials are well known in the art of ink jetting and may include surfactants and humectants to provide the integrity and shape of the droplets of solvents and to prevent drying on the jetting nozzles. As previously stated, the composition of the solvent applied by the pads may be different from the jetting solvent.

The composition of an optimum solvent for use in the present invention is dependent on the exact coating composition that must be dissolved and removed. It should be obvious to one skilled in the art that the various solvents described herein are not limiting in the present invention, but are given merely as examples of materials known to be suitable for the general coating types described herein. Alternative classes of alkaline materials or organic solvents are equally suitable in the present invention when matched with a coating that has the required solubility in the respective alkaline material or organic solvent. Further, resins or polymers other than those specifically described herein may also be equally useful within the scope of the present invention. The solvents that are useful for these other resins or polymers may or may not be similar to those described herein.

1. A method of forming a desired positive image on a lithographic printing plate having leading and trailing ends and side edges and comprising a hydrophilic substrate with an oleophilic coating thereon wherein said coating is soluble in selected solvent compositions, said method comprising the application in a desired pattern of a first selected solvent composition to said coating by jet printing thereby dissolving away said coating in said desired pattern and thus exposing said hydrophilic substrate and forming a residual oleophilic coating in the form of the desired positive image on the hydrophilic substrate and comprising the further step of separately applying a second selected solvent composition to said coating on said leading and trailing ends of said plate.

2. A method as recited in claim 1 wherein said step of separately applying said second selected solvent composition comprises the step of contacting an absorbent pad containing said second selected solvent composition with said leading and trailing ends.

3. A method as recited in claim 1 wherein said first and second selected solvent compositions are the same.

4. A method as recited in claim 2 wherein said first and second selected solvent compositions are the same.

5. A method as recited in claim 1 and further including the step of separately applying said second selected solvent composition to said coating on said side edges.

6. A method as recited in claim 5 wherein said step of separately applying said second selected solvent composition to said coating on said side edges comprises the step of contacting absorbent pads containing said second selected solvent composition with said side edges.

7. A method as recited in claim 5 wherein said first and second selected solvent compositions are the same.

8. A method as recited in claim 6 wherein said first and second selected solvent compositions are the same.

9. A method of forming a desired positive image on a lithographic printing plate having leading and trailing ends and side edges and comprising a hydrophilic substrate with an oleophilic coating thereon wherein said coating is soluble in selected solvent compositions, said method comprising the application in a desired pattern of a first selected solvent composition to said coating by jet printing thereby dissolving away said coating in said desired pattern and thus exposing said hydrophilic substrate and forming a residual oleophilic coating in the form of the desired positive image on the hydrophilic substrate and comprising the further step of separately applying a second selected solvent composition to said coating on one or more of said ends and side edges.

10. A method as recited in claim 9 wherein said step of separately applying said second selected solvent composition comprises the step of contacting an absorbent pad containing said second selected solvent composition with said one or more ends and side edges.

11. A method as recited in claim 9 wherein said first and second selected solvent compositions are the same.

12. A method as recited in claim 10 wherein said first and second selected solvent compositions are the same.

13. A method as recited in claim 9 and further including the step of hardening said residual oleophilic coating.

14. A method as recited in claim 9 wherein said coating is selected from the group consisting of novalac resins, resole resins, acrylate resins, diazo resins and photopolymers.

15. A method as recited in claim 9 wherein said coating has a composition which may be insolubilized by actinic radiation and further including the step of post treating with actinic radiation to insolubilize said residual oleophilic coating.

16. A method as recited in claim 15 wherein said coating comprises a photopolymer or a diazo resin or mixtures thereof.

17. A method as recited in claim 9 wherein said coating has a composition which may be hardened by heating and further including the step of post treating by heating to harden said residual oleophilic coating.

18. A method as recited in claim 17 wherein said coating comprises a phenolic resin.

19. A method as recited in claim 9 wherein said selected solvent compositions are aqueous solutions.

20. A method as recited in claim 19 wherein said aqueous solution is a solution of sodium metasilicate.

21. A method as recited in claim 19 wherein said aqueous solution is an aqueous alkaline solution.

22. A method as recited in claim 9 wherein said selected solvent compositions comprise an organic solvent.

23. A method as recited in claim 19 wherein said aqueous solution contains an organic solvent.

24. A method as recited in claim 23 wherein said aqueous solution is an aqueous alkaline solution.

25. A method as recited in claim 24 wherein said aqueous solution comprises a solution of sodium metasilicate: and said organic solvent is benzyl alcohol.

26. A method as recited in claim 22 wherein said organic solvent is selected from the group consisting of ketones, alcohols, ethers and ether linked alcohols and acetates.

27. A method as recited in claim 26 wherein said solvent is selected from the group consisting of methyl ethyl ketone, cyclohexanone, acetone, glycol ethers, dioxane, benzyl alcohol, 1-methoxy-2-propanol and 3-methoxyethyl acetate.

28. A method of forming a desired positive image on a lithographic printing plate having leading and trailing ends and side edges and comprising a hydrophilic substrate with an oleophilic coating thereon wherein said coating is soluble in selected solvent compositions, said method comprising conveying said plate through a jet printer and while said plate is being conveyed performing the steps of:
a. applying a first selected solvent composition to said coating by jet printing in a desired pattern thereby dissolving away said coating in said desired pattern and thus exposing said hydrophilic substrate and forming a residual oleophilic coating in the form of the desired positive image on the hydrophilic substrate;
b. applying a second selected solvent composition to said coating on said leading and trailing ends of said plate; and
c. detecting said leading and trailing ends of said plate and controlling the applications of said first and said second selected solvent compositions in response to said detections of said leading and trailing ends.

29. A method as recited in claim 28 and further performing the steps of applying said second selected solvent composition to said coating on said side edges.

30. A method as recited in claim 29 and further comprising the steps of detecting said side edges and controlling the application of said second selected solvent composition to said side edges in response to said detections of said side edges.

31. Apparatus for forming a desired positive image on a lithograpic printing plate having leading and trailing ends and side edges and comprising a hydrophilic substrate with an oleophilic coating thereon wherein said coating is soluble in selected solvent compositions, said apparatus comprising a jet printer adapted to apply a first selected solvent composition to said coating in a desired pattern thereby dissolving away said coating in said desired pattern and thus exposing said hydrophilic substrate and forming a residual oleophilic coating in the form of the desired positive image on the hydrophilic substrate and further comprising means for separately applying a second selected solvent composition to said coating on said leading and trailing ends of said plate.

32. Apparatus as recited in claim 31 wherein said means for separately applying said second selected solvent composition comprises an absorbent pad adapted to contain said second selected solvent composition and means for contacting said absorbent pad with said leading and trailing ends.

33. Apparatus as recited in claim 32 wherein said means for contacting said absorbent pad with said leading and trailing ends comprises means for reciprocating said absorbent pad across said ends.

34. Apparatus as recited in claim 31 and further comprising means for separately applying said second selected solvent composition to said coating on said side edges.
